(19) United States
(12) Patent Application Publication
(10) Pub. No.: US 2019/0351822 A1
(43) Pub. Date: Nov. 21, 2019

(54) LIGHTING MODULE

(71) Applicant: Nano-Lit Technologies Limited, Edinburgh (GB)

(72) Inventor: Sarah MORGAN, Edinburgh (GB)

(73) Assignee: Nano-Lit Technologies Limited, Edinburgh (GB)

(21) Appl. No.: 16/476,184

(22) PCT Filed: Jan. 5, 2018
(86) PCT No.: PCT/GB2018/050025

§ 371 Date: Jul. 5, 2019

(30) Foreign Application Priority Data
Jan. 5, 2017 (GB) 1700141.3

(51) Int. Cl. B60Q 3/208; B60Q 3/64; H05B 33/08

(52) U.S. Cl. CPC B60Q 3/208; H05B 33/0851; H05B 33/086; B60Q 3/64

(57) ABSTRACT

A light module comprises a light source, an optical mixing element or chamber and a spectral converting diffuser for tuning the wavelength and spatially homogenising the intensity of the ouptut light from the light source. Also disclosed is a method of improving Colour Rendering Index (CRI) of a lighting device. The disclosed lighting module is coupled with the lighting device. Use of the disclosed lighting module in conjunction with a lighting device is also described.

### CROSS-REFERENCE TO RELATED APPLICATIONS

This application is a U.S. National Stage Application of International Patent Application No. PCT/GB2018/050025, filed Jan. 5, 2018, which claims benefit of United Kingdom Patent Application No. 1700141.3, filed Jan. 5, 2017.

### FIELD OF THE INVENTION

The present disclosure relates to a lighting module. The lighting module may be used as a standalone module or with an existing luminaire.

### BACKGROUND OF THE INVENTION

There are many types of illumination available, such as incandescent lamps, arc lamps, metal vapour lamps, discharge tubes, various types of fluorescent lamps and more recently light emitting diode (LED)-based lamps. While there are many ways to create light, human colour vision evolved using the light from the sun and it is this to which all other lighting systems are compared. An important feature of human vision is the ability to identify many different colours. Colour vision results from a complex interaction between illumination, the properties of the object being viewed, the physiology of the eye, and the processing of visual stimulae by the human brain.

In order to reliably perceive the colour of an object, it is important that the object be illuminated with wavelengths of light that closely mimic the light of the sun. Some artificial light sources such as arc lamps do an excellent job of this, while others such as certain types of fluorescent lamps or LED-based lamps do not. This variability in the quality of colour rendering of illumination has been quantified, in a measure known as the colour rendering index (CRI) of a light source. After brightness of illumination this is one of the most important characteristics of a light source, particularly light sources designed to illuminate commercial facilities such as offices, manufacturing facilities and retail facilities such as stores or shopping malls. Light sources with high quality colour have a colour rendering index approaching 100, the value for natural lighting by the sun.

LED based lamps have become popular due to their energy efficiency and long lifetime, and are increasingly being incorporated in luminaires for office and home use.

A luminaire is an enclosure that provides a way of mounting a lamp or light source and can incorporate electrical connectors, power conditioners or converters, light directing elements such as reflectors and light diffusing elements such as the moulded plastic panels often seen in fluorescent lamp luminaires in an office. While LED based luminaires have advantages there are also disadvantages. LED luminaires are more costly to make, but do not require regular replacement of bulbs or fluorescent tubes because they lose much less of their brightness over time. Older type luminaires required frequent lighting element replacement and so changes in colour illumination properties over time were also easily rectified. This is not the case with LED luminaires, since the LEDs are permanently mounted on circuit boards and generally require replacement of the entire luminaire or at least a major component.

Another problem with LED luminaires is that while they may be bright and efficient, the Colour Rendering Index (CRI) may not be suitable for all types of uses. Another problem facing LED luminaires is that they are composed of multiple types of LEDs and over long periods of time the colour properties of the different LEDs may change relative to one another, resulting in changes in the colour of the light emitted.

Another issue of luminaire aging is that the life times of the different types of LEDs may vary. For example, over a period of years the efficiency of certain LEDs of one colour in the luminaire might change, while a percentage of LEDs of a different colour in the luminaire might fail or change in efficiency at a different rate, producing a gradual change in colour properties of the output light from the luminaire.

Another problem of using LED luminaires results from slight variations between luminaires when newer luminaires or luminaires from different manufacturers are added to a space, such as an office, for example to increase brightness or replace failed or damaged systems. The luminaires may not have an exact match in colour and this can produce an undesirable aesthetic effect due to perception of the luminaire colour mismatch.

The use of e.g. a combination of “cool-white” or “warm-white” LEDs may allow moving over a line close to the black body locus. Some LED luminaires may suffer from low colour quality or the cost for making the LED of higher quality is prohibitive and leads to a lowering of the energy efficiency.

At least one embodiment of the present invention aims to provide an alternative illumination device and method of use thereof, which obviates one or more of above-described drawbacks.

### SUMMARY OF THE INVENTION

Described herein is a lighting module, which may provide improved Colour Rendering Index (CRI). The lighting module may be used as a source of light and/or may be used with or fitted to existing lights/luminaires in order to modify, tune, homogenise or alter light output thereby.

As such, the present invention provides a lighting module comprising:

a light source;

an optical mixing element or chamber; and

a colour shift element.

The light source may comprise at least one Light Emitting Diode (LED). The light source may comprise an arc lamp. The light source may comprise a metal vapour lamp. The light source may comprise a fluorescent lamp. The light source may comprise a discharge tube. The light source may comprise an incandescent lamp.

The lighting module may comprise two or more light sources of the same type. The lighting module may comprise two or more light sources of different types. The lighting module may comprise light sources of three or more different types.

The lighting module may comprise two, three or more light sources configured to emit light of different chromaticities and/or colours.

One or more of the light sources may emit visible light. The light sources may emit in the ultraviolet, indigo, violet, blue, green, yellow, orange and/or red regions of the visible spectrum of light.

The lighting module may, for example, comprise three LED types. The light module may comprise one or more LEDs configured to emit light of a first colour and/or chromaticity, one or more LEDs configured to emit light of a second colour and/or chromaticity and one or more LEDs configured to emit light of a third colour and/or chromaticity. LEDs of different types may be aligned. LEDs of different types may be disposed in a strip. The light source may comprise repeat units of LEDs configured to emit light of different colours. The light source may comprise, for example, repeat units of red, green and blue LEDs in an aligned configuration. The repeat units of LEDs of different colours and/or chromaticities may be disposed in an aligned configuration. The combined output of the repeat units of LEDs may be any type of visible light. The combined output of the repeat units of LEDs may be white light. The output of the lighting module may be white light. The output of the lighting module may be warm white light. The output of the lighting module may be cold white light.

The term white light relates to light having a correlated colour temperature (CCT) between about 2000 and 20000 K, especially 2700-20000 K, for general lighting especially in the range of about 2700 K and 7500 K and especially within about 15 SDCM (standard deviation of colour matching) from the black body locus (BBL), especially within about 10 SDCM from the BBL, even more especially within about 5 SDCM from the BBL. The term “predetermined colour” may relate to any colour within the CIE standard representation of colour space, but may especially refer to white light.

The terms “blue light” or “blue emission” refer to light having a wavelength in the range of about 410-490 nm. The term “green light” relates to light having a wavelength in the range of about 500-570 nm. The term “red light” relates to light having a wavelength in the range of about 590-650 nm. The term “yellow light” relates to light having a wavelength in the range of about 560-590 nm. The term “light” herein relates to visible light, i.e. light having a wavelength selected from the range of about 380-780 nm.

These terms do not exclude that a light source or luminescent material or element may have a broad band emission having emission with wavelength(s) outside the range of for instance about 500-570 nm, about 590-650 nm, and about 560-590 nm, respectively. However, the dominant wavelength of emissions of such luminescent materials or elements (or of the light source, respectively) will be found within the ranges described above. Hence, the phrase “with a wavelength in the range of” indicates that the emission may have a dominant emission wavelength within the specified range.

The output emission of each light source may be independently modified or tuned. Each LED may be independently tuneable by modification of the current applied to each LED. Independently modifying or tuning the emission of each light source may enable the lighting module to generate a light output of the desired colour point and/or correlated colour temperature. Independently modifying or tuning the emission of each light source may enable chromaticity tuning. Independently modifying or tuning the emission of each light source may enable correlated colour temperature tuning of the illumination device light, for example by varying the amount of light injected by each light source or light source type. Thus, the colour point and correlated colour temperature (CCT) may be varied as function of the ratio of the injected light. This may lead to an illumination device that also allows moving substantially along the black body locus. A wide range of warm and cold light may be produced by controlling the electrical power supplied to each LED element, depending upon the requirements of the user and/or depending upon predefined parameters. The use of three different chromaticity LEDs may enable to cover a wide range of the white colour space by providing colour tuning across a wide range of wavelengths while staying close to the plankian locus. In contrast, the use of two different chromaticity LEDs only permits to cover half of the white light colour space with acceptable deviation from the black body locus (BBL), when compared with three colour LEDs.

The colour shift element may be formed and adapted to modify, control, supplement or tune the wavelength of light from the light source. The colour shift element may be configured to homogenise, e.g. spatially homogenise, the light from the light source. The colour shift element may be configured to homogenise the intensity of the light from the light source.

The colour shift element may be provided in the form of a diffuser. For example, the lighting module may comprise a diffuser which itself comprises a colour shift element. The colour shift element may be applied to the diffuser (or some substrate) as a coating or as a layer.

The lighting module may comprise a plurality of colour shift elements.

The, or each, colour shift element may be configured to emit light of a predetermined colour. The, or each, colour shift element may be configured to absorb light and emit light in a different colour to the absorbed light.

The colour shift element may comprise a material capable of emitting light. The colour shift element may comprise a luminescent material. The colour shift element may comprise an organic luminescent material. The colour shift element may comprise an inorganic luminescent material. The colour shift element may comprise a material capable of being optically excited to emit light. The colour shift element may comprise an electroluminescent material, which is a material capable of being electrically excited to emit light.

The colour shift element may comprise a phosphor. The colour shift element may comprise an organic light emitting polymer. The colour shift element may comprise an organic light emitting small molecule. The colour shift element may comprise a luminescent inorganic material. The colour shift element may comprise Quantum Dots (QDs).

Quantum Dots are nanocrystals with a core of semiconductors materials selected from the group comprising but not limited to PbS, PbSe, CdSe, CdS, ZnS, ZnSe, CuInS, CuInS2 and other like materials. Quantum Dots may further have an overcoating (or shell) of material selected from the group comprising but not limited to ZnS, ZnSe, CdS, CdSe, CdTe or MgSe. The overcoating may improve the efficiency of the Quantum Dot to convert light from one wavelength to another. Quantum dots may comprise as few as 100 atoms or as many as 100,000. These atoms may be arranged in a three dimensional shell like structure and can range between 2 nm and 10 nm in diameter. This shell may form a three dimensional confinement region limiting the allowable energy states of excited electrons. This in turn may limit the amount of energy in the form of photons that can be generated when the electron collapses to the ground state. By controlling the size of the shell the energy and hence wavelength of emitted photons can be tuned. Different sizes of Quantum Dots may be mixed to create multiple wavelengths of emission from the same excitation source. Quantum Dots may be suspended in a host solution, embedded in a host substrate, and/or mixed into a coating that can be painted or evaporated onto surfaces. Quantum Dots may be commercially available or may be synthesised in a laboratory.

Quantum Dots may be excited to emit photons using optical energy and/or electrical energy. The intensity of light emitted from a material, substrate or coating comprising Quantum Dots is proportional to the number of Quantum Dots available to be excited and the amount of excitation energy applied.

Quantum Dots may absorb light of a first wavelength and emit light of a second wavelength. The wavelength of emission of a Quantum Dot material may be selected to match the required output emission of the lighting module.

Quantum Dots may be excited by ultra-violet light to emit violet, blue, green, yellow, orange or red. Quantum Dots may be excited by violet light to emit blue, green, yellow, orange or red light. Quantum Dots may be excited by blue light to emit blue, green, yellow, orange or red light. Quantum Dots may be excited by green light to emit green, yellow, orange or red light. The combination of violet, blue, green, yellow, orange and red light may cover the whole range of colours of the visible spectrum of light. Other colours such as indigo, cyan are also encompassed by the present disclosure, as it would be appreciated by someone skilled in the art.

The colour shift element may be embedded in a substrate. A substrate comprising colour shift element may be spaced from the light source. The colour shift element may be applied as a coating, laminate or film. As stated, a coating comprising the colour shift element may be spaced from the light source.

As stated, spacing the colour shift element from a light source may increase the lifetime reliability of the colour shift element, for example by preventing degradation of the colour shift element by exposure of the colour shift element to an elevated temperature as might be emitted by a light source.

The lighting module disclosed herein may exploit a mixture of colour shift elements each emitting substantially different colours within the visible spectrum. As stated, these colour shift elements may be applied to a substrate as a film or coating.

The colour shift element may be applied to a surface of the lighting module. For example, a coating comprising the colour shift element may be applied as a layer to one or more wall(s) of the optical mixing element or chamber.

A coating comprising the colour shift element may be applied to or coated on an outside surface of the mixing chamber.

The colour shift element may be contained within or dispersed in a material forming part of the optical mixing chamber or element itself.

The colour shift element may additionally include or comprise a diffusive transmissive material. One of skill will appreciate that the term “diffusive” indicates that something is permeable to light but also scatters light in a direction which is substantially different to the original direction of the light (but may also include a portion of the light being transmitted in the original direction). A diffusive material can be both reflective and transmissive in nature. A diffusive material may permit parts of the visible wavelength region to pass through and be scattered by the diffusive material. A diffusive material may permit substantially the entire visible region of the spectrum (i.e. 380-780 nm) to pass through and be scattered by the diffusive material. In general, the term diffusive herein indicates that all or part of the visible light is permitted to pass at least partly through the diffusive material.

A lighting module of this disclosure may comprise more multiple layers of colour shift elements. The term “layer” may comprise one or more layers of substrate and/or coating comprising the colour shift element. Thus, the term layer may also be interpreted in an embodiment as a plurality of layers. Layers may for instance be arranged adjacent, non-adjacent or on top of each other. A layer may be coated on part of the optical mixing element or chamber, such as on a wall and/or the base of the optical mixing element or chamber, but such wall or base of the optical mixing element or chamber may also be partly coated with such layer. The layer may be deposited on a transmissive glass or polymer, or may be disposed in and/or on a transmissive organic material.

The lighting module may comprise an optical mixing element or chamber.

The optical mixing element or chamber may be disposed between the light source and the colour shift element or diffuser. The effect of this is that the colour shift element (or any diffuser comprising the same) may be spaced from the light source by the optical mixing element/chamber.

Disposing an optical mixing chamber or element between the colour shift element and the light source may allow mixing of the light output from the light source by the mixing chamber/element prior to arriving at the colour shift element, this may reduce the incidence of high intensity spots of light from the light source at the colour shift element. This may reduce the glare of the output of the lighting module and it may increase the lifetime of the colour shift element.

Spacing the colour shift element from the light source may increase the percentage of backscattered light from the colour shift element that is reflected back onto said colour shift element prior to exiting the lighting module, thus resulting in high system efficacy.

The optical mixing element may comprise at least one input surface arranged to receive light from the light source. The at least one input surface of the optical mixing element may be provided along a longitudinally extending or long side of the optical mixing element. The light source may be configured to provide light directly to the input surface of the optical mixing element.

The optical mixing element or chamber may mix the light output of the light source and the colour shift element. The use of a highly diffuse reflecting cavity optic in the optical mixing element or chamber may recycle the backscattered light from the colour shift element, this resulting in the lighting module emitting a homogeneous light colour.

The optical mixing element or chamber may comprise a circuit to supply electric current or power to the light source. The circuit may be a printed circuit board (PCB).

The optical mixing element or chamber may comprise or take the form of a waveguide. The light output of the light source may be injected in the waveguide.

The waveguide may guide the electromagnetic waves of the output light from the light source and/or the colour shift element. The waveguide may be a slab waveguide. The waveguide may be an optical fibre. The waveguide may be a channel waveguide. The waveguide may comprise a dielectric material. The waveguide may comprise a high refractive index material. The waveguide may guide waves inside the waveguide by total internal reflection. The waveguide may confine the electromagnetic waves and propagate them in only one dimension. The waveguide may mitigate losses of electromagnetic waves while propagating through the waveguide.

The light source may be disposed in the optical mixing element or chamber. The light source may be completely enclosed within the optical mixing element or chamber. The light source may be at least partially disposed within and/or embedded in the optical mixing element or chamber.

The lighting module may comprise one or more reflective elements. For example, the one or more reflective elements may be provided on one or more surfaces of the optical mixing element or chamber. As such the optical mixing element or chamber may comprise at least one reflective element, surface, coating or member. An internally reflective surface, coating or member may be provided on one or more of the optical mixing element/chamber surface(s), for example one or more of the, or each, longitudinally extending or long side of the optical mixing element that is not provided with a colour shifting element (or SCD) or the input surface. The reflective elements/surfaces may be formed, adapted and arranged so as to recirculate light from the light source within the optical mixing chamber or element.

The at least one reflective surface, coating or member may comprise a MCPET (microcellular polyethylene terephthalate) and/or Barium Sulphate (BaSO4)g. The optical mixing element or chamber may comprise at least one opening or exit face. As stated, the at least one reflective wall may recirculate the light inside the optical mixing element or chamber prior to exiting the optical mixing element or chamber through the at least one exit face. Recirculating the light of the lighting module prior to exiting the lighting module may lead to efficient mixing of light, for example mixing of light from different light sources and/or light of different wavelengths. The optical mixing element or chamber may reduce the glare of the light source by recirculating the light inside the chamber prior to exiting the chamber. The optical mixing element or chamber may provide a uniform colour distribution of the output light from the lighting module. The optical mixing element or chamber may provide a Colour Rendering Index (CRI) close to 100, which is indicative of a high colour quality.

The lighting module described herein may take any shape or form. For example the module may be elongate, for example, cuboid or an elongate cylinder. The light source, colour shift element (or diffuser) and optical mixing chamber or element (disposed therebetween) may co-extend. The lighting module may be shaped as a strip. The lighting module may be substantially round. The shape of the lighting module may enable the lighting module to be fitted or retrofitted to an existing luminaire. For example, the lighting modules described herein may be used to provide additional edge lighting within an existing luminaire. That is to say, the lighting modules of this invention may be fitted around the edges of an existing luminaire.

The lighting module may comprise more than one transmissive support(s). One or more of the transmissive supports may comprise a colour shift element. For example, two or more of the transmissive supports may comprise different luminescent materials.

The lighting module may comprise air gaps between the different components of the module. The lighting module may comprise optically matching materials between the different components of the lighting module. The presence or absence of air gaps or optically matching materials may be designed by a person skilled in the art to either promote escape of the light or to reflect the light back into the optical mixing element or chamber for recirculation of light within the optical mixing element or chamber. For example, the promotion of reflectance into a medium may occur as a consequence of a large refractive index step between the medium in which the light is contained and the medium into which it exits. Alternatively, substantial matching of refractive indices between materials promotes transfer of light from one material into another suppressing internal reflection caused through the total internal reflection mechanism.

The lighting module described herein may comprise a spectral converting diffuser (SCD). The SCD may be configured to tune the wavelength of the light source. The SCD may be configured to spatially homogenise the intensity of the output light from the light source. The SCD may be spaced or remote from the light source. The SCD may be disposed between the light source and an opening or exit face in the optical mixing element or chamber. The SCD may be provided along a longitudinally extending or long side of the optical mixing element, e.g. a different or opposite longitudinally extending or long side of the optical mixing element to the input surface.

The SCD may scatter light, reflect light and/or refract light. The SCD may even out the spatial distribution of the light from the lighting module that illuminates an area, scene or object.

The SCD may comprise a substrate that is transparent or partially transparent to the output of the light source. The substrate may maintain the structural integrity of the SCD.

The substrate of the SCD may comprise an inorganic material. The substrate of the SCD may comprise an inorganic material selected from the group comprising, but not limited to glass, (fused) quartz, ceramic materials, silicones.

The substrate of the SCD may comprise a transparent organic material. The substrate of the SCD may comprise a transparent polymeric or acrylic material. The substrate of the SCD may comprise a transparent polymeric material selected from the group comprising, but not limited to, polystyrene, polyimide, PE (polyethylene), PP (polypropylene), PEN (polyethylene napthalate), PC (polycarbonate), polymethylacrylate (PMA), polymethylmethacrylate (PMMA) (Plexiglas or Perspex), cellulose acetate butyrate (CAB), polycarbonate, polyvinylchloride (PVC), polyethyleneterephthalate (PET), (PETG) (glycol modified polyethyleneterephthalate), PDMS (polydimethylsiloxane), and COC (cyclo olefin copolymer) or epoxy.

The transparent organic material may be shaped into the SCD by injection molding, 3D printing or a similar additive manufacturing process.

The SCD may be disposed inside or within the optical mixing element or chamber. The SCD may be disposed outside the optical mixing element or chamber.

The SCD may comprise light diffusing elements. The spectral converting diffuser may comprise light transforming or diffusing elements printed and/or deposited onto a surface of the spectral converting diffuser. Light transforming and/or diffusing elements may be printed or deposited onto a surface comprising part of the optical mixing element or chamber, rather than being on a separate film or other standalone structure.

The colour shift element disclosed herein (which element may comprise quantum dots) may be disposed in and/or on the spectral converting diffuser. The lighting module may comprise a colour shift element exclusively disposed in and/or on the SCD. The lighting module may comprise a colour shift element disposed outside the spectral converting diffuser. The lighting module may comprise a colour shift element disposed in and/or on the spectral converting diffuser and additional a colour shift element disposed outside the spectral converting diffuser. Substantially all the colour shift element may be disposed in and/or on the spectral converting diffuser (SCD).

The lighting module may comprise a colour shift element disposed on one or more walls of the light mixing cavity. The colour shift element may be applied as a coating one or more walls of the optical mixing element or chamber. The colour shift element may be disposed as a coating on the spectral converting diffuser (SCD). The colour shift element may be applied as a coating on one or more surfaces of the spectral converting diffuser (SCD). The colour shift element may be applied as a coating on the surface of the spectral converting diffuser that faces away from the light source. The colour shift element may be applied as a coating on the surface of the spectral converting diffuser that faces the light source. Disposing a layer of a coating comprising colour shift element on a surface of the spectral converting diffuser that faces the light source benefits from the remote (i.e. spaced) location of the colour shift element from the light source as well as from a relatively remote location of the colour shift element from the exit face of the optical mixing element or chamber.

The lighting module may comprise circuitry for applying an electrical field to an electroluminescent colour shift element. For example, the lighting module may comprise circuitry for applying an electrical field to Quantum Dots. Providing Quantum Dots that can be optically and electrically excited to generate light may enable to inject wavelengths of light into the output of the lighting module both as a result of optical excitation of the quantum dots by the light source of the lighting module as well as electrical excitation of the quantum dots via the circuitry of the lighting module.

The lighting module may comprise at least one sensor. The sensor(s) may each be integral to (or with: in other words, part of) a lighting module of this disclosure. The, or any one or more of the sensor(s), may be remote in that they are not integral to or with a lighting module of this disclosure. Remote sensors may collect and transmit information to a lighting module described herein. The sensors may have Bluetooth or other wireless capability to transmit and/or receive data, for example, from a lighting module device described herein.

It should be noted that the term “sensor” will be used hereinafter to refer to both sensor(s) which are integral to or with a lighting module device of this disclosure and those that are remote to a lighting module described herein.

The sensor(s) may be used to collect certain information that allows the lighting module to “tune” the light it outputs. The sensor(s) may provide information related not only to the light output of the lighting module, but also light output by any luminaire to which a lighting module of this invention is attached and any ambient (or other) light. All of this information can be assessed and processed and used to tune the light emitted by the lighting module and/or a luminaire comprising the same.

The sensor(s) may continually collect and process information such that the light output by the lighting module (and/or the total light output by any luminaire to which it is fitted) is continually tuned to take account of changing ambient conditions and the like.

Additionally or alternatively, a sensor of the device described herein may be programmed to collect information at specific predetermined time points.

A sensor may be configured to detect the light output from the light source. The sensor may be configured to detect the light output reflected from the optical mixing element or chamber. The sensor may be configured to detect the light output from the spectral converting diffuser. The sensor may be configured to detect the light output from the light source, the light output reflected from the optical mixing element or chamber and/or the light output from the spectral converting diffuser. The sensor may be configured to detect the light output from another light or luminaire.

The sensor may be insensitive to illumination outside the lighting module. This may enable the output of the lighting module to be monitored over time and adjusted to match the required parameters. The sensor may be configured to detect one or more optical properties from the sensed light and to generate a sensor signal.

The devices (lighting modules) described herein may further comprise sensors which monitor and/or collect information relating to one or more environmental stimuli or factors. This information can be further used to tune the light output by the lighting module.

The lighting module may comprise a motion sensor. For example a user may perform a movement or gesture to indicate that the ambient light characteristics should be changed. For example, a particular or specific movement or gesture may indicate that the light intensity and/or colour of the lighting module (or luminaire comprising the same) must be modified.

The lighting module may comprise a sensor to detect, monitor and/or measure one or more human or animal vital signs. For example a sensor may be used to detect, monitor, measure and/or sense one or more of biological (life sign) data, blood pressure, temperature, pulse rate, oxygen saturation, muscle (including heart muscle) activity, brainwaves (or brain activity), and the like. Sensors of this type may be applied, for example to one or more users in a room and light tuned in response to certain vital sign information or data received by a lighting module of this invention

The lighting module may comprise a brainwave sensor. The brainwave sensor may sense α, β, γ, and/or θ brainwaves. This information may be transmitted to a lighting module of this disclosure such that in response to specific or certain brainwave patterns or data, output light (that is light output by a lighting module of this invention or light output by a luminaire comprising the same) can be tuned. The use of sensors which monitor information about the physical and/or biological status of a user may allow the light output of the lighting module to be modified to improve the ambient light which in turn may improve the mind-set, wellbeing, health and/or physical status of a user. For example, the light output of the lighting module (and/or any luminaire to which it is attached) may be adjusted to match the circadian rhythm of a specific user. This may enable a user manage his/her attention and/or stress level and/or to wake up, sleep, and/or relax.

The efficiency of LED luminaires may decrease and the colour output may change over time, leading to a reduction of the Lux level. The use of a sensor (e.g. an integrated sensor) to detect the intensity of the light output of the lighting module may indicate the need to modify (e.g. increase) the current provided to the LEDs of the lighting module as the efficiency of the lighting module decreases, in order to ensure that the intensity of the light output of the lighting module is maintained constant over time. Furthermore, the use of a sensor (e.g. an integrated sensor) to detect the properties of the light output of the or each LED of the lighting module may allow the colour of each LED to be corrected through modification of the current supplied to each LED to keep the colour of emission of each LED balanced over time.

The lighting module may comprise at least one controller. The controller may report and control the chromaticity of the light output from the lighting module in real time. The controller may be configured to receive a sensing signal from the sensor and control (e.g. maintain or modify) the electrical current applied to the light source of the lighting module. This way, the controller may ensure that light output from the lighting module matches predetermined parameters or parameters input by a user into the controller. The controller may tune the output light from the lighting module to the required colour point and/or correlated colour temperature, in response to the sensor signal. The controller may maintain the colour point and/or correlated colour temperature during the lifetime of the lighting module, by modifying the current provided to the light source in order to compensate for changes in the light output which may occur as a result of high temperature or during the lifetime of the light source of the lighting module. The lighting module may provide long-term light output and colour stability through the use of a sensor that measures the combined light from the light source, the reflector and the SCD (whose characteristics may also change due to elevated temperature or over the lifetime of the light source) and a controller to correct the current provided to the light source, in order to compensate for variations in the output of the lighting module.

The lighting module may be capable of optical shaping. The lighting may comprise optical shaping optic components to redirect the light output from the light module onto the target illumination zone. The target illumination zone may be a waveguide, for example a waveguide located outside the optical mixing element or chamber, or a waveguide of another lighting device with which the lighting module is coupled. The target illumination zone may be a scene or task that requires light.

The sensor may be located on an edge of an elongated lighting module. The sensor may be located contiguously to a linear end of the optical mixing element or chamber. The sensor may sense a proportion of the light from each light source. The sensor may sense a proportion of the light reflected in the optical mixing element or chamber. The sensor may sense a proportion of the light from the spectral converting diffuser.

The lighting apparatus may comprise a protective seal. The protective seal may prevent contact of the colour shift elements with air and/or moisture. The light output conversion properties of Quantum Dots tend to deteriorate rapidly in contact with air and/or moisture. The use of a protective seal may prevent increase the lifetime of the colour shift element by contact with air and/or moisture. The colour shift element may be sealed within the optical mixing element or chamber by means of a protective seal.

The protective seal may comprise a polymer selected from the group comprising, but not limited to, polystyrene, polyimide, PE (polyethylene), PP (polypropylene), PEN (polyethylene napthalate), PC (polycarbonate), polymethylacrylate (PMA), polymethylmethacrylate (PMMA) (Plexiglas or Perspex), cellulose acetate butyrate (CAB), polycarbonate, polyvinylchloride (PVC), polyethyleneterephthalate (PET), (PETG) (glycol modified polyethyleneterephthalate), PDMS (polydimethylsiloxane), and COC (cyclo olefin copolymer) or epoxy. The protective seal may comprise silica glass. The protective seal may comprise a printed ink.

The lighting module may be capable of providing edge light. The lighting module may be configured to be coupled to, retrofitted to or associated with an existing light source or luminaire. The lighting module may be configured to provide additional edge lighting for an existing light source or luminaire. The lighting module may be configured to be inserted around the edges of a standard light source or luminaire. The lighting module may be configured to be inserted around the edges of a standard ceiling mounted light, such as a fluorescent light. The lighting module may be configured to be retrofitted or coupled to a transmissive or partially transmissive sunroof, such as a car sunroof.

The lighting module may be arranged such that the light source and/or the SCD is substantially invisible to an observer (which is external from the illumination device (i.e. downstream of the exit face of the optical mixing element or chamber) when the illumination device is in the “off state”.

The lighting module may be capable of tuning the optical properties of the light output of the lighting module. The lighting module may have an efficient light output. The light output of the lighting module may have low glare. The diffusion of the light output from the light source through the optical mixing element or chamber and through the Spectral Converting Diffuser may increase the spot size of the light output of the lighting module, thus reducing the glare of the lighting module. The lighting module may be configured to alter the light output in response to the circadian rhythm of a user. For example, the colour, temperature, or intensity of the light output of the lighting module may change at a certain time of the day, and/or in response to ambient light (or other source of (artificial) light), to affect the mood or state of a user. Beneficially, the light output of the lighting module may reduce fatigue, assist in the relaxation, and induce sleep, and/or energise a user. This may be used, for example, to increase productivity or reduce the risk of accidents at times of the day when a user feels tired, or it may be used to assist a user in relaxing and inducing sleep. Applications of this sort may be classed as human centric lighting applications.

The lighting module may be used as a standalone lighting device. The lighting module may be used in conjunction with an additional lighting device. The lighting module may be coupled to or retrofitted into a luminaire to modify the light output from the luminaire. The lighting module may be coupled to or retrofitted to a transmissive or partially transmissive sunroof. The lighting module may have elongated shape and it may be coupled to the edges of a luminaire or a sunroof in order to modify the light output from the luminaire or sunroof.

The lighting module may allow chromaticity tuning and/or correlated colour temperature tuning of the illumination device lighting module, by varying the amount of light injected by each light source (e.g. LED). In this way, the colour point and correlated colour temperature (CCT) may be varied as function of the ratio of the injected light. This may advantageously lead to a lighting module that also allows moving substantially along the black body locus, something that is for instance hardly possible with conventional lighting products.

Hence, a wide range of warm and/or cold light (e.g. white light) may be produced by controlling the electrical power supplied to the or each light source of the lighting module (e.g. LED), depending upon the requirements of a user and/or depending upon predefined Colour rendering Index (CRI) parameters.

Advantageously, the exact emitted light power and/or chromaticity may be altered based on changes to the performance of the lighting module. The performance of the lighting module may depend on the performance of the at least one light source (e.g. LEDs), the spectral converting diffuser (SCD) and/or the reflecting side walls in the mixing chamber with time and/or temperature. The performance of the lighting module may further depend on measurements taken by a sensor.

In a second aspect there is provided a computer program product configured such that, when implemented on a processing device, the computer program causes the processing device to receive sensed information about a light output of a lighting device, compare the characteristics of a light output of the lighting device with a set of target values, determine the parameters of the light output of the lighting device that differ from the set of target values, and adjust the power supplied to a light source of a lighting module according to any one of claims 1 to 19 which is coupled to the lighting device to obtain a light output of the lighting module that complements the light output of the lighting device in order to achieve a light output with the required characteristics and/or target values.

In a third aspect there is provided a controller for controlling the light output of a lighting module and/or a lighting device, the controller comprising a processing device, the controller being configured to receive sensed information about a light output of a lighting device, compare the characteristics of a light output of the lighting device with a set of target values, determine the parameters of the light output of the lighting device that differ from the set of target values, and adjust the power supplied to a light source of a lighting module according to any one of claims 1 to 19 which is coupled to the lighting device to obtain a light output of the lighting module that complements the light output of the lighting device in order to achieve a light output with the required characteristics and/or target values.

In a fourth aspect there is provided a method of modifying or tuning the light output from a luminaire, said method comprising fitting a lighting module of this invention to the luminaire. For example a lighting module as described herein may be retrofitted onto at least one side or edge of an existing luminaire. The method may allow the light output of an existing luminaire to be modified. The method may be performed to modify the light output of an existing luminaire to match the light output of luminaires located in the vicinity of the luminaire, for example in order to prevent colour miss-match. The method may be performed to modify the light output of an existing luminaire to correct changes in the intensity and/or chromaticity of the light output of the luminaire that may have occurred over time due to ageing.

In a fifth aspect there is provided a method of modifying light emitted from a lighting device, such as an existing luminaire. The method may comprise sensing the light output of the lighting device. The method may comprise sending the sensed information about the light output of the lighting device to a controller. The method may comprise inputting the Colour Rendering Index (CRI) requirements into the controller. The method may comprise comparing the characteristics of the light output of the lighting device with a set of target values. The target values may comprise a predetermined CRI. The target values may be defined by a predetermined lookup table or algorithm. The target value may comprise a CRI input by a user. The method may comprise determining the parameters of the light output of the lighting device that differ from a set of target values.

The method may comprise adjusting the power supplied to the light source of the lighting module to obtain a light output of the lighting module that complements the light output of the lighting device in order to achieve a light output with the required characteristics and/or target values. The method may comprise combining the light output of the lighting module and the lighting device to obtain a modified combined light output. Combining the light output of the lighting module and the lighting device may comprise injecting the light output from the lighting module into the lighting device. The method may comprise injecting the light output from the lighting module into the lighting device through an edge of the lighting device. The method may comprise sensing the corrected light output from the lighting device and sending the sensed information to the controller to ensure that the corrected light output of the lighting device has the required Colour Rendering Index (CRI). The method may comprise further modifying the light output of the lighting module until the corrected light output of the lighting device has the required Colour Rendering Index (CRI). The method may comprise sensing the corrected light output of the lighting device at regular intervals and sending the information to the controller to ensure that the required light output characteristics are maintained.

A retrofitted lighting module may provide edge lighting into the existing lighting device, for example a luminaire. Retro-fitting the lighting module into an existing lighting device may improve the Colour Rendering Index (CRI) of the existing lighting device. Retrofitting the lighting module into an existing lighting device may provide an improved Colour Rendering Index (CRI) of the light output from the lighting device while only using a limited amount of colour shift element. Quantum Dots are expensive materials and the use of Quantum Dots as colour shift elements in the lighting module reduces the surface area of Quantum Dots necessary to achieve the improved CRI of the lighting device (e.g. a luminaire) compared to using an active diffuser with Quantum Dots disposed across the entire surface area of the diffuser of the lighting device. Retrofitting an existing luminaire with the lighting module may provide the required Colour Rendering Index (CRI) from the lighting device without the need to replace the lighting device and/or without the need to replace the diffuser of the lighting device with an active diffuser. Therefore, retrofitting an existing lighting device with the lighting module may be an economical way of achieving a light output with the characteristics from the lighting device, such as a given CRI, intensity and/or wavelength.

In a sixth aspect there is provided a use of a lighting module to modify or tune the light output of a luminaire. For example, a lighting module of this invention may be used in conjunction with a second light source. The lighting module may be used in conjunction with a luminaire or sunroof. The lighting module may be retrofitted to a luminaire or sunroof.

The lighting modules described herein may find use in human centric lighting applications. Thus an aspect of the invention relates to the use of any of the lighting modules described herein in methods or applications of or for achieving human centric lighting. Further, the invention provides methods of providing human centric lighting, said methods exploiting a lighting module of this invention. The lighting modules may be fitted or retro-fitted to existing lights so that the native (original or unmodified) light output of that light is tuned for human centric purposes. In this way, light of any sort (including light from luminaires, lamps, lights (LEDs) used to light devices/components, lights used in car or vehicle control panels and/or dashboards, of even light emitted through windows or sunroofs) can be modified, tuned or homogenised in order to improve or modulate circadian rhythms, human mood(s), visual acuity and human performance. These human centric applications may be achieved through the use of dimming, CCT shifting (kelvin changing or shifting) effects all imparted by a lighting module of this disclosure. One of skill will appreciate that human centric lighting can be provided by fitting a lighting module of this invention to any existing light (or source of light—perhaps for example as an edge lighting component to a window, sunroof, device or luminaire) such that light output by that existing light can be modified or tuned in a manner (through combination with light from the lighting module—which light may be modified according to one or more sensed and processed parameters) to provide human centric lighting.

### BRIEF DESCRIPTION OF THE DRAWINGS

FIG. 1 shows a structural diagram of an LED luminaire 100 according to an embodiment of the prior art.

FIG. 2 shows a spectrum of LED emission from a phosphor based white LED which would typically be achieved by an LED luminaire as shown in FIG. 1.

FIG. 3 shows an exploded view of a general construction of a lighting module 200.

FIG. 4 shows typical spectra of Quantum Dot films comprising Quantum Dots emitting light of different colours.

FIG. 5 shows the spectral shape of emission of a white light source comprising a blue LED coated with a phosphor (dotted line) and the emission of the same phosphor LED coupled with a layer of red emitting Quantum Dot (solid line).

FIG. 6 shows a longitudinal section and a cross-section of a lighting module 300 according to one embodiment.

FIG. 7 shows a CIE 1931 colour space (X,Y) of a Quantum Dot film for use in the lighting module, for example in the Spectral Converting Diffuser of the lighting module.

FIG. 8 shows a table presenting the Chromaticity Shift expressed in CIE 1931 colour space (X,Y) and denoted by the correlated colour temperature (CCT) between each incident LED (LED1, LED2 and LED3) and after transmission through the SCD-QD film in mixing cavity.

FIG. 9 shows a longitudinal section and a cross-section of a lighting module 400 according to another embodiment.

FIG. 10 shows a longitudinal section and a cross-section of a lighting module 500 according to another embodiment. In this embodiment the Spectral Converting Diffuser 530 is disposed on the internal surface of the bottom wall of optical mixing element or chamber 520 between the LED light sources 510a,b,c and the waveguide 540.

FIG. 11 shows a longitudinal section and a cross-section of a lighting module 600 according to another embodiment.

FIG. 12 shows a cross-section and a longitudinal section of a lighting module 700 according to another embodiment.

FIG. 13 shows a cross-section and a longitudinal section of a lighting module 800 according to another embodiment.

FIG. 14 shows a cross-section and a longitudinal section of a lighting module 900 according to another embodiment.

FIG. 15 shows a cross-section and a longitudinal section of a lighting module 1000 according to another embodiment.

FIG. 16 shows a cross-section and a longitudinal section of a lighting module 1100 according to another embodiment.

FIG. 17 shows a cross-section and a longitudinal section of a lighting module 1200 according to another embodiment.

FIG. 18 shows a cross-section and a longitudinal section of a lighting module 1300 according to another embodiment.

FIG. 19 shows a block diagram representation of an embodiment of a control and controller for a lighting module as described herein.

### DETAILED DESCRIPTION OF THE INVENTION

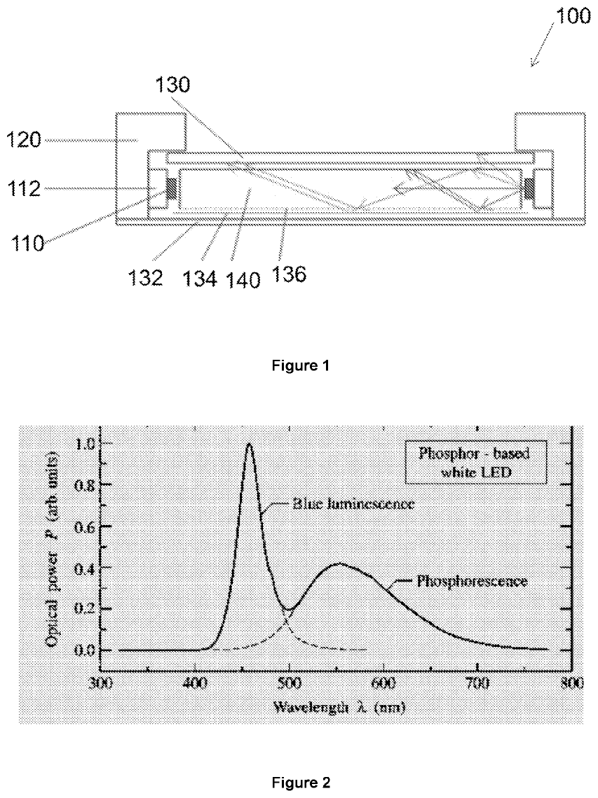

FIG. 1 shows a structural diagram of an LED luminaire 100 according to an embodiment of the prior art. The luminaire 100 comprises two LED light sources 110 connected to a printed circuit board (PCB) 112 to mechanically support and electrically connect the LEDs. The LEDs 110 are disposed within an optical mixing element or chamber 120, which is substantially U-shaped and comprises a back plate 132 coated with a back reflector 134 and ink or reflective materials 136. Disposed within the optical mixing element or chamber 120 is a waveguide 140 for guiding the light towards the opening of the optical mixing element or chamber 120. A diffuser 130 is disposed inside the optical mixing element or chamber 120, closing the opening or exit face of the chamber 120. Diffuser 130 scatters, reflects and/or refracts light to spatially homogenise the intensity of the output light from the LED 110. Light emitted from the LED (red, green and blue arrows) is directed into waveguide 140 where it is guided by total internal reflection within the waveguide and it is recycled within the optical mixing element or chamber 120 (see red arrows) until it exits the luminaire 100 through the diffuser 130 (green arrows).

Shown in FIG. 2 is a spectrum of LED emission from a phosphor based white LED which would typically be achieved by an LED luminaire as shown in FIG. 1. It can be observed that the LED pump has a narrow peak of blue emission around 450 nm and the emission of the phosphor that coats the LED pump is much broader and appears at longer wavelengths ranging from about 500 to about 700 nm.

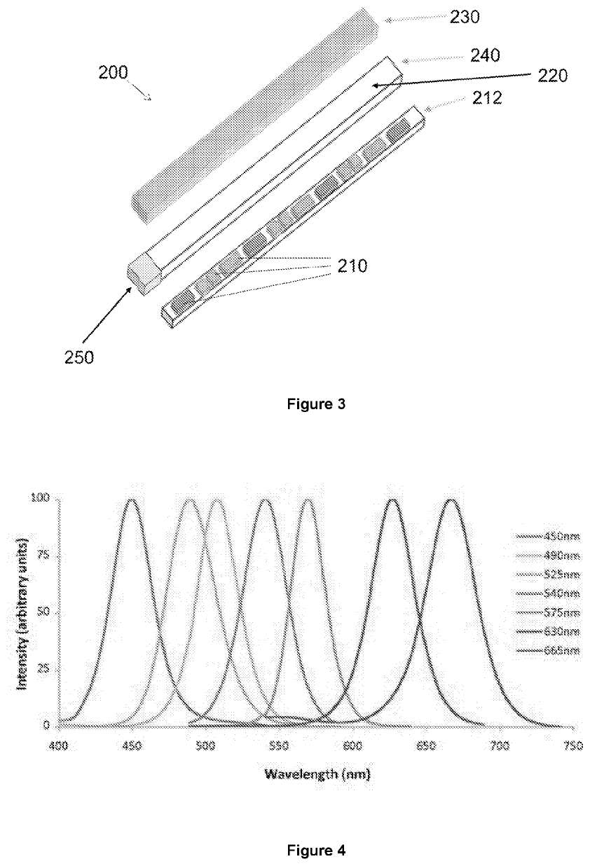

FIG. 3 shows an exploded view of a general construction of a lighting module 200. Lighting module 200 comprises several repeat units of high efficacy LEDs 210 emitting light of different colours. LEDs 210 are connected to a thermally efficient high-density multi-channel PCB.

Disposed over the LEDs 110 is a polymethylmethacrylate (PMMA) waveguide 240 coated with a microcellular foamed reflector of microcellular polyethylene terephthalate (MCPET) to form a optical mixing element or chamber 220 with reflective walls around the waveguide 240.

Lighting module 200 has a substantially elongate shape with LEDs 210 being aligned along the length of the lighting module 200 in a series of repeat units of LEDs of different colours.

Disposed on top of the waveguide 240 is a Spectral Converting Diffuser (SCD) 230. The SCD 230 scatters, reflects and/or refracts the light output of LEDs 210 in order to enable the light to be recirculated as it is reflected by the MCPET walls of the optical mixing element or chamber 220 and to exit the SCD as a light output which is homogeneous in colour and intensity. The spectral converting diffuser (SCD) tunes the wavelength of emission of LEDs 210 and evens out the spatial distribution of the light from the lighting module 200 that illuminates an area, scene or object and reduces the glare of the lighting module 200. The spectral converting diffuser (SCD) 230 comprises a substrate transparent or partially transparent to the output of the LEDs 210 and maintains the structural integrity of the (SCD). Spectral converti diffuser 230 comprises Quantum Dots (QDs) as colour shift elements. The Quantum Dots can be optically excited by the emission of LEDs 210 and it can be additionally excited by a circuitry that applies an electrical field to excite the Quantum Dots (QD). The Quantum Dots can absorb part of the light output of LEDs 210 and emit at a different wavelength in order to inject further wavelengths to the combined output light of the lighting module. SCD 230 has a textured surface to provide increased mixing of the light emitted by LEDs 210 and the Quantum Dots of the SCD. Optionally further QD materials may be coated onto optical mixing element or chamber 220 in order to have additional emission of light from the QDs which can either be reflected back into the cavity 210 or be used to out-couple the light directly for non-directional lighting applications. Alternatively, if different light output characteristics are required, QD materials could be exclusively coated on the walls of optical mixing element or chamber 220 and with the SCD not comprising any QD material.

Lighting module 200 also comprises an integrated colour/illuminance sensor 250 disposed on one end of the waveguide 240. Sensor 250 continuously assesses the colour and light level of the output emission from the lighting module. Sensor 250 assumes colour mixing of the light output of each LED 210 within the optical mixing element or chamber 220 and it can also assess the contribution from each LED 210.

Lighting module 200 can be used as a standalone lighting device or it can be retrofitted to an existing luminaire to change the emission characteristics of the luminaire. Lighting module 200 is capable of edge lighting. Retrofitting lighting module 200 to an existing luminaire on one side of the luminaire results in injection of the light output of lighting module 200 into the luminaire in order to obtain a combined light that matches the requirements of a user or predetermined values. This may be advantageous since the light output of existing luminaires can be modified, for example to provide illumination for a different purpose or to match the emission of another luminaire which is located in the vicinity in order to avoid mismatch of emission from the different luminaires.

FIG. 4 shows typical spectra of films comprising Quantum Dots emitting light of different colours. The spectra show narrower emission peaks compared to the broad emission of LED phosphors and therefore different Quantum Dots can be mixed together to create specific colour mixes. The beneficial inclusion of quantum dots provides a means of introducing spectral features which can more precisely influence the colour and efficacy of LED lighting through the specific nature and narrow emission profile of each Quantum Dot formulation, which can also be mixed together to create a specific spectral shape.

FIG. 5 shows the spectral shape of emission of a white light source comprising a blue LED coated with a phosphor (dotted line) and the emission of the same phosphor LED coupled to a layer of red emitting Quantum Dot (solid line). It can be observed that the Quantum Dot film absorbs blue light, thus decreasing the intensity of the blue emission peak of the LED around 460 nm and transforms the absorbed blue light into mostly red light (see the new peak appearing around 650 nm). Therefore, coupling a typical phosphor white LED with a film of red-emitting Quantum Dot leads to substantial warming of the colour of the LED and increase in the Colour Rendering Index (CRI) or colour quality even at high colour temperatures.

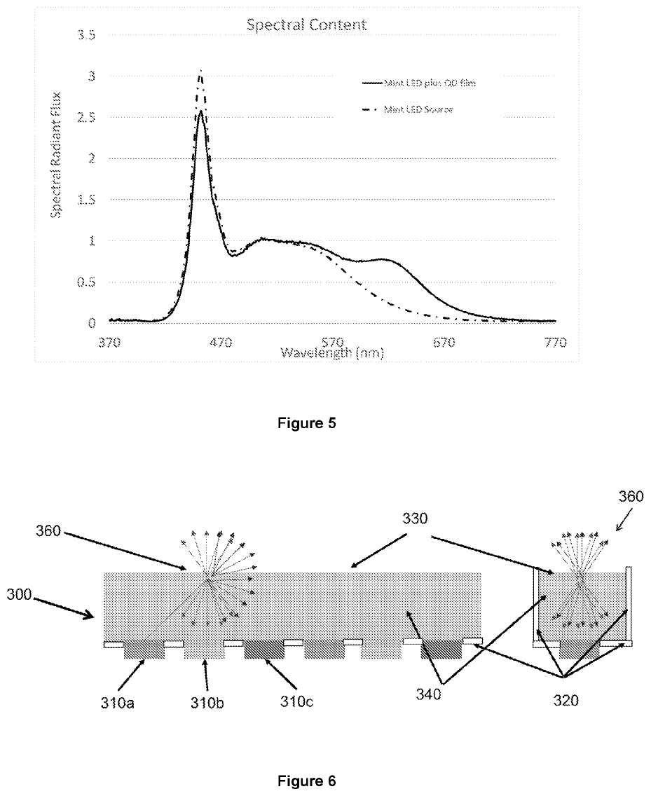

FIG. 6 shows a longitudinal section and a cross-section of a lighting module 300 according to one embodiment. Lighting module 300 has a series of three different types of LEDs 310a, 310, 310c, each emitting light with a different spectrum. LEDs 310a,b,c are disposed along the length of the lighting module and embedded in a bottom wall of an optical mixing element or chamber 320, which has highly reflective walls.

Module 300 comprises an optically clear waveguide 340 disposed inside optical mixing element or chamber 320 over the LEDs 310a,b,c.

Also disposed within the optical mixing element or chamber 320, near the opening of the chamber 320 and over the waveguide 340 is a Spectral Converting Diffuser 330 comprising Quantum Dot material.

Light emitted by LEDs 310 a, b and c is injected into waveguide 340, which guides the light towards the SCD 330 located at the exit face of optical mixing element or chamber 320. The Quantum Dot material of the SCD transfoms the wavelength of the light absorbed by the QD and emits light in all directions as shown in 360. Light is guided within waveguide 340 in a zig-zag fashion, thus increasing the recirculation or recycling of light within the optical mixing element or chamber 320 when the light is reflected back from the highly reflective walls of the chamber 320. The recycling of light allows optical mixing element or chamber 320 to efficiently mix the light from LEDs 310a, b and c and also to recycle the light emitted by the Quantum Dot material disposed on or within the Spectral Converting Diffuser (SCD) 330 and which is backscattered from the SCD 330. The pattern of emitted and transformed light rays is shown as 360. The multiple reflections of the light within the optical mixing element or chamber 320 provide diffuse scattering in the side walls of the lighting module 300 and further diffuse scattering is achieved by means of the SCD 330.

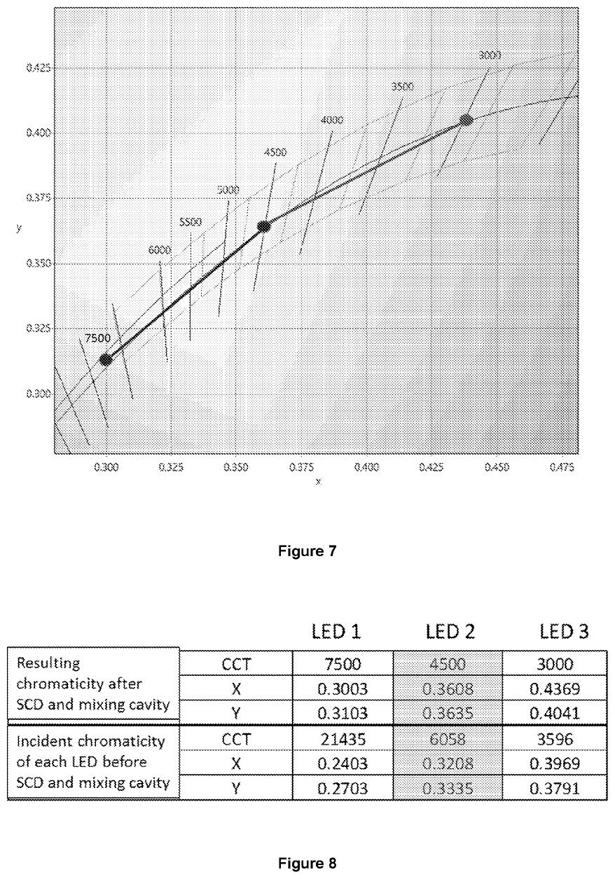

FIG. 7 shows a CIE 1931 colour space (X,Y) of a Quantum Dot film for use in the lighting module, for example in the Spectral Converting Diffuser of the lighting module. The resulting chromaticity and colour shift describe a wide colour tuning range achieved at high colour rendering index (CRI) and when a SCD with Quantum Dot materials to shift the chromaticity of LED light sources of a lighting module as shown previously. This colour range covers the human centric lighting chromaticity, which provides the beneficially enhancing effects of cold white light 5500-7500K (to boost productivity and learning) as well as the relaxing effects at the warmer colour temperatures (3000-4000K). Further arrangements are envisaged to span towards lower colour temperatures to 2000K and higher colour temperatures out towards 20,000K for enhanced effects.

Advantageously, the lighting module may allow the possibility of chromaticity tuning and/or correlated colour temperature tuning of the light output of the lighting module, by varying the amount of light injected by each LED. In this way, the colour point and correlated colour temperature (CCT) may be varied as function of the ratio of the injected light. This may advantageously lead to a lighting module that also allows moving substantially along the black body locus, something that is for instance hardly possible with conventional lighting products.

The light output of each LED of the lighting module can be modified by changing the electrical power supplied to each LED. This way, a wide range of warm and cold light may be produced by controlling the electrical power supplied to each LED element, depending upon the wishes of the user and/or depending upon predefined parameters.

FIG. 8 shows a table presenting the Chromaticity Shift expressed in CIE 1931 colour space (X,Y) and denoted by the correlated colour temperature (CCT) between each incident LED (LED1, LED2 and LED3) and after transmission through the SCD-QD film in mixing cavity. This table shows the type of change in chromaticity between the LED light and the light emitted from the light source expected through the use of the mixing chamber and SCD.

The exact intensity, colour and/or chromaticity of the output light of the lighting module may be altered based on changes to the performance of the LEDs, SCD or reflecting side walls in the optical mixing element or chamber with time or temperature or other conditions due to the measurement of the sensor, which may be built into the system or provided separately.

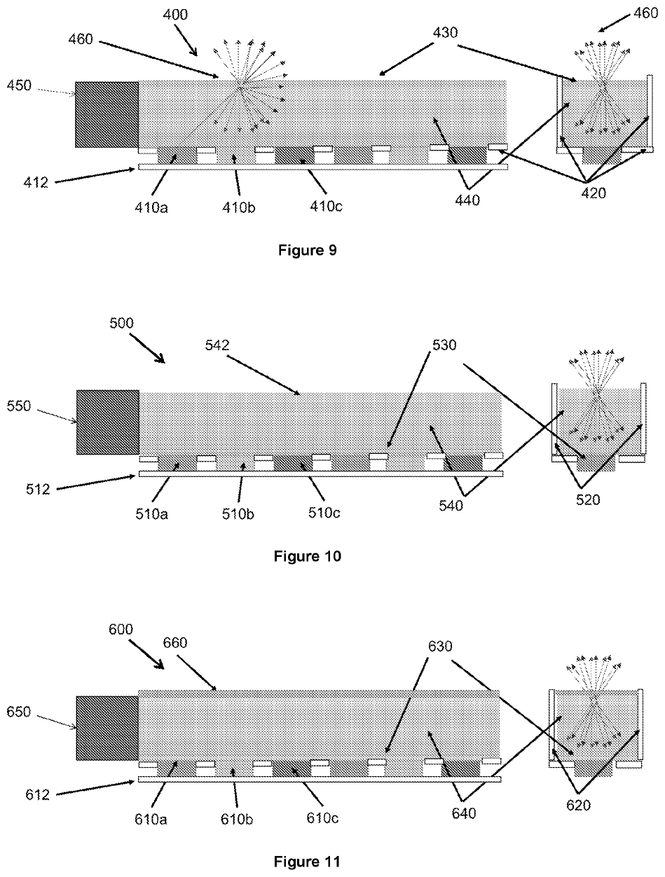

FIG. 9 shows a longitudinal section and a cross-section of a lighting module 400 according to another embodiment. Like features have similar reference numerals as the lighting module 300 of FIG. 6. Lighting module 400 has a series of three different types of LEDs 410a, 410, 410c, each emitting light with a different spectrum. LEDs 410a,b,c are disposed along the length of the lighting module and embedded in a bottom wall of an optical mixing element or chamber 420, which has highly reflective walls. LEDs 310 are connected to a printed circuit board (PCB) 412 to support mechanically and connect electrically the LEDs 310. The current supplied to each LED 310 can be modified by the PCB in order to tune the emission wavelength of the LEDs.

Module 400 comprises an optically clear waveguide 440 disposed inside optical mixing element or chamber 420 over the LEDs 410a,b,c.

Also disposed within the optical mixing element or chamber 420, near the opening or exit face of the chamber 420 and over the waveguide 440 is a Spectral Converting Diffuser 430 comprising Quantum Dot material. The Quantum Dot material of the SCD 430 transfoms the wavelength of the light absorbed by the QD and emits light in all directions as shown in 460.

Lighting module 400 comprises a sensor 450 which detects the mixed colour of the different LEDs 410a,b,c and the light emitted by the Quantum Dots of the SCD 430. Sensor 450 sends the sensed signal to a controller (not shown) to control and adjust the relative amount of light emitted from each LED 410 by means of the electric power supplied to each LED 410, in order to maintain a colour balance within the module which is independent from any light external to the luminaire.

FIG. 10 shows a longitudinal section and a cross-section of a lighting module 500 according to another embodiment. In this embodiment the Spectral Converting Diffuser 530 is disposed on the internal surface of the bottom wall of optical mixing element or chamber 520 between the LED light sources 510a,b,c and the waveguide 540. The wavelength of emission of each LED 510 a, b and c respectively is transformed on entry into the optical mixing element or chamber 520. The light is then injected into waveguide 540 and it is recycled and backscattered with some further transformation by the reflective walls of optical mixing element or chamber 520 and by the SCD 530. The surface 542 of waveguide 540 facing out from optical mixing element or chamber 520 is able to inject the mixed light from the three different types of LEDs 510a, b and c and the light emitted by the Quantum Dots of the SCD 530 into an external waveguide or to illuminate a scene or task.

Sensor 550 detects the mixed colour of the different LEDs 510a,b,c and the light emitted by the Quantum Dots of the SCD 530. Sensor 550 sends the sensed signal to a controller (not shown) to control and adjust the relative amount of light emitted from each LED 510 by means of the electric power supplied to each LED 510, in order to maintain a colour balance within the module which is independent from any light external to the luminaire. Sensor 550 is substantially insensitive to any light external to the lighting module 500 or a luminaire to which the lighting module can be coupled.

FIG. 11 shows a longitudinal section and a cross-section of a lighting module 600 according to another embodiment. This embodiment has the same construction as the embodiment of FIG. 10, but in this embodiment the Spectral Converting Diffuser (SCD) 630 is located on the internal surface of the bottom wall of optical mixing element or chamber 620 between the LED light sources 610a,b,c and the waveguide 640. LEDs 610 are connected to PCB 612 and one end of the elongated lighting module 600 has an integrated sensor 650 to sense the light output from the lighting module 600 as well as the individual contributions to the output from each LED 610a,b,c and the Quantum Dot material from the SCD 630.

The outer surface of waveguide 640 which faces out from optical mixing element or chamber 620 is covered with a layer of diffusing or beam shaping optics 660 to alter the optical profile with good colour mixing. The layer of diffusing or beam shaping optics 660 comprises light transforming or diffusing elements printed and/or deposited thereon and therefore in this embodiment there are light transforming or diffusing elements on the SCD 630 as well as outside the SCD on layer 660.

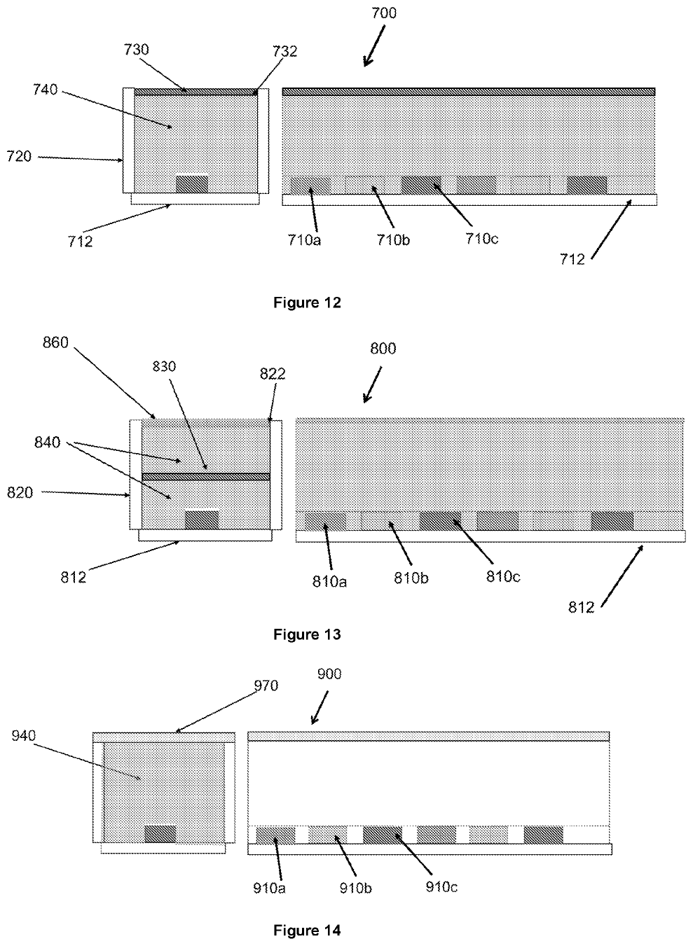

FIG. 12 shows a cross-section and a longitudinal section of a lighting module 700 according to another embodiment. The bottom wall of optical mixing element or chamber 720 is a PBC 712 which provides power to LEDs emitting in different wavelengths 710a, b, c. Therefore in this embodiment LEDs 710a,b,c are effectively disposed inside the optical mixing element or chamber 720, on the inner surface of its lower wall. As in previous embodiments, the walls of optical mixing element or chamber 720, including the PBC, are highly reflective by means of a highly reflective coating such as BaSO4 or MCPET. LEDs 710a,b,c are embedded in a transparent plastic or glass optical waveguide 740 which is also disposed within the optical mixing element or chamber 720. The uppermost layer of the lighting module 700 optical mixing element or chamber is a Spectral Converting Diffuser 730 comprising Quantum Dot material. SCD 730 but is disposed within the volume of the optical mixing element or chamber 720 and the edges 722 of the exit face of the optical mixing element or chamber 720 are sealed to reduce chances of air and moisture entering in contact with the Quantum Dot film of the SCD 730 and degrading it.

FIG. 13 shows a cross-section and a longitudinal section of a lighting module 800 according to another embodiment. Lighting module 800 has a similar construction to lighting module 700 of FIG. 12 but SCD 830 is disposed towards the centre of the optical mixing element or chamber 820, sandwiched between transparent plastic or glass optical waveguide 840 and spaced from LEDs 810a,b,c and from the exit face of the optical mixing element or chamber 820. As in module 700, LEDs 810a,b,c are connected to a PBC 812 for power supply, the PBS also acting as the lower call of the optical mixing element or chamber 820.

Optionally, the exit face of optical mixing element or chamber 820 may comprise a layer of diffusing or beam shaping optics 860 to redirect the light onto the target illumination zone via an additional waveguide or to illuminate a scene or task. Therefore, this embodiment has beam shaping optics on the downstream (emitting) end of the lighting module 800. Sealing the edges 822 of the exit face of the optical mixing element or chamber 820 reduces chances of air and moisture entering in contact with the Quantum Dot film present in SCD 830 and degrading it. The layer of diffusing or beam shaping optics 860 comprises light transforming or diffusing elements printed and/or deposited thereon and therefore in this embodiment there are light transforming or diffusing elements on the SCD 830 as well as outside the SCD on layer 860.

FIG. 14 shows a cross-section and a longitudinal section of a lighting module 900 according to another embodiment. Lighting module 900 has a similar construction to lighting module 700 but the SCD is formed by dispersing or adding Quantum Dot colour shift element to a matrix of transparent polymer, glass or liquid material 940 which acts as a waveguide inside optical mixing element or chamber 920 and surrounds LEDs 910a,b,c. The exit face of optical mixing element or chamber 920 is sealed with an optically transparent sealing film 970 to prevent moisture the Quantum Dot degradation by contact with air or moisture.

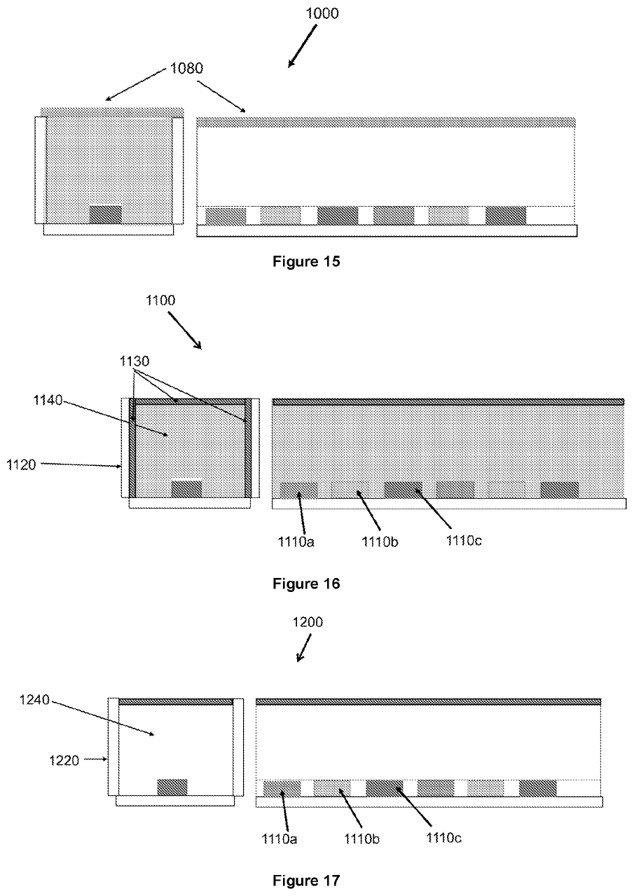

FIG. 15 shows a cross-section and a longitudinal section of a lighting module 1000 according to another embodiment. Lighting module 1000 has the same construction as lighting module 900 but instead of the optically transparent sealing film 970 it has a beam shaping optics film 1080 comprising light transforming and/or diffusing elements. Beam shaping optics film 1080 may be printed to redirect the light onto the target illumination zone which may lead into a waveguide or to illuminate a scene or task. For example, the beam shaping optics film 1080 may enhance the brightness of the light output of the lighting module 1000. Beam shaping optics 1080 may seal the edges of the optical mixing element or chamber to prevent moisture or air entering in contact with the Quantum Dot material.

FIG. 16 shows a cross-section and a longitudinal section of a lighting module 1100 according to another embodiment. Lighting module 1100 has the same construction as lighting module 700 but it comprises SCD disposed on the side walls of the optical mixing element or chamber 1120 as well as along the exit face of the optical mixing element or chamber. Therefore in this embodiment the SCD 1130 surrounds three surfaces of waveguide material 1140 thus maximising the amount of light from the LEDs 1110a,b,c that enters in contact with the SCD 1130. The use of SCD 1130 surrounding the side walls and emitting surface (i.e. exit face) of the optical mixing chamber 1120 enhances the transformation of light utilising those wavelengths which are not transformed to be transmitted through the SCD and then reflected from the highly reflecting side walls of the optical mixing element or chamber 1120 that are behind the SCD 1140. SCD 1140 is sealed within the edges of optical mixing element or chamber 1120 in order to minimise the amount of air and moisture that enter in contact with the Quantum Dot material and therefore minimising the degradation of the Quantum Dots.

FIG. 17 shows a cross-section and a longitudinal section of a lighting module 1200 according to another embodiment. Lighting module 1200 has the same construction as lighting module 700 but the optical mixing element or chamber 1220 is filled with air or an inert gas 1240 rather than with a waveguide. The refractive index of air or inert gas may enhance a large percentage of light from the LEDs 1110a,b,c to exit the optical mixing element or chamber 1220 after being recycled by reflection on the highly reflective walls of the optical mixing element or chamber.

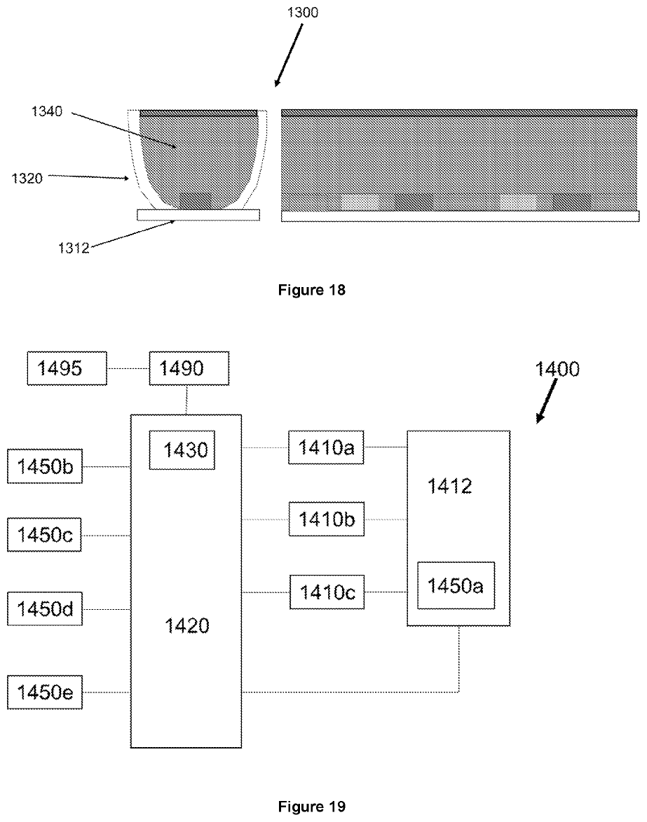

FIG. 18 shows a cross-section and a longitudinal section of a lighting module 1300 according to another embodiment. Lighting module 1300 has the same construction as lighting module 700 but instead of having a rectangular optical mixing element or chamber and rectangular waveguide, the optical mixing element or chamber 1320 and the waveguide 1340 define a U-shape in order to direct light into a forward direction, for example for task illumination rather than ambient illumination.

FIG. 19 shows a block diagram representation of an embodiment of a control and controller for a lighting module as described herein. The lighting module 1400 comprises a PBC LED panel 1412 supporting a colour sensor 1450a and three LEDs 1410a, 1410b and 1410c. The LEDs are coupled to an optical mixing element or chamber 1420 with highly reflective walls to recirculate the light output of the LEDs 1410 and provide homogeneous mixing of the light. Optical mixing element or chamber 1420 contains an SCD 1430 to tune the wavelength of the mixed output light from the LEDs and change the optical characteristics, for example by diffractive elements contained in the SCD 1430. The lighting module 1400 is connected with an ambient light sensor 1450b, a PIR sensor 1450c, a gesture sensor 1450d and a temperature, humidity and barometric pressure sensor 1450e. The output of the sensed light is connected to a Wi-Fi module 1490 which directs the information to a controller 1495 that reports and controls the chromaticity of the light output from the lighting module 1400 in real time.

1-35. (canceled)

36. A lighting module comprising:
a light source;
an optical mixing element or chamber; and
a colour shift element.

37. The lighting module of claim 36, wherein the colour shift element is spaced from the light source.

38. The lighting module of claim 36, wherein the optical mixing element or chamber is disposed between the light source and the colour shift element.

39. The lighting module of claim 36, wherein colour shift element tunes the wavelength and/or spatially homogenises the intensity of the output light from the light source.

40. The lighting module of claim 36, wherein the light source comprises two or more separate or distinct light sources emitting light of different chromaticities or spectral regions.

41. The lighting module of claim 36, wherein the colour shift element comprises quantum dots.

42. The lighting module of claim 36, wherein the mixing chamber comprises a waveguide for injecting the light output from the light source.

43. The lighting module of claim 36, wherein the light source comprises at least one Light Emitting Diode (LED).

44. The lighting module of claim 43, wherein the lighting module comprises a plurality of LEDs emitting light of different chromaticities or spectral regions.

45. The lighting module of any one of claim 43, wherein the light output of each LED is independently tuneable.

46. The lighting module of any one of claim 43, wherein the light output of each LED is independently tuneable by modification of the current applied to each LED.

47. The lighting module of claim 36, wherein the lighting module further comprises at least one sensor configured to detect the light output from one or more of:
the light source;
another light or luminaire,
light reflected from the optical mixing element or chamber; and/or
light from the colour shift element.

48. The lighting module of claim 47, wherein the at least one sensor is insensitive to illumination outside the lighting module.

49. The lighting module of claim 47, wherein the optical mixing element or chamber is elongated and the at least one sensor is located contiguously to a linear end of the optical mixing element or chamber.

50. The lighting module of claim 36, wherein the optical mixing element or chamber comprises at least one reflective wall to recirculate light inside the mixing chamber prior to exiting the mixing chamber.

51. The lighting module of claim 36, wherein the lighting module comprises at least one controller configured to receive a signal or data from the sensor and control the electrical current applied to the light source of the lighting module.

52. The lighting module of claim 36, wherein a spectral converting diffuser is disposed between the light source and the optical mixing element or chamber or an opening therein.

53. The lighting module of claim 52, wherein the spectral converting diffuser is further disposed on a wall of the optical mixing element or chamber.

54. The lighting module of claim 36, wherein the lighting module comprises a protective seal to prevent contact between the colour shift element and air and/or moisture.

55. The lighting module of claim 36, wherein the lighting module emits white light.

56. The lighting module of claim 36, wherein the lighting module is an elongate module.

57. The lighting module of claim 36, wherein the lighting module is for fitting or retro-fitting to another luminaire or light or to a vehicle sunroof in a vehicle.

58. The lighting module of claim 36, wherein the lighting module is used to provide edge lighting, additional edge lighting or supplementary edge lighting to another luminaire or light or sunroof.

59. The lighting module of claim 36, wherein the lighting module is used to tune, homogenise, alter or modify the light from a device, lit component, another luminaire or light and/or light emitted by or through a vehicle sunroof.

60. A method of constructing a lighting device, which device is capable of modifying its light output, the method comprising:
coupling a lighting module according to claim 36 with a lighting device.

61. A method of modifying the native light output of a lighting device, said method comprising fitting or retro-fitting a lighting module of claim 36 to the lighting device.

62. The method of claim 61, wherein the method is used to tune the native light output by the lighting device.

63. The method of claim 62, wherein in use, the lighting module or a sensor thereof:
determines the light output from the lighting device; and
adjusts the light source of the lighting module to emit light that when combined with the native the light output of the lighting device, modifies or tunes the light output of the lighting device.

64. The method of claim 63, further comprising:
inputting the Colour Rendering Index requirements into a controller of the lighting module; and
injecting light from the lighting module through an edge of the lighting device.

65. A computer program product configured such that, when implemented on a processing device, the computer program causes the processing device to receive the light output of a lighting device, compare the characteristics of a light output of the lighting device with a set of target values, determine the parameters of the light output of the lighting device that differ from the set of target values, and adjust the power supplied to a light source of a lighting module according to claim 36 which is coupled to the lighting device to obtain a light output of the lighting module that complements the light output of the lighting device in order to achieve a light output with the required characteristics and/or target values.

66. A controller for controlling the light output of a lighting module and/or a lighting device, the controller comprising a processing device, the controller being configured to receive sensed information about a light output of a lighting device, compare the characteristics of a light output of the lighting device with a set of target values, determine the parameters of the light output of the lighting device that differ from the set of target values, and adjust the power supplied to a light source of a lighting module according to claim 36 which is coupled to the lighting device to obtain a light output of the lighting module that complements the light output of the lighting device in order to achieve a light output with the required characteristics and/or target values.

67. A vehicle or vehicle sunroof comprising a lighting module according to claim 36.
